(19) United States
(12) Patent Application Publication
(10) Pub. No.: US 2013/0336546 A1
(43) Pub. Date: Dec. 19, 2013

(54) BIOMETRIC ENCLOSURE FOR A MOBILE DEVICE

(71) Applicants: Joseph Justin Pritikin, Mountain View, CA (US); William Homer Chandler, JR., Milpitas, CA (US); Fayez Mahmood Khan, San Jose, CA (US)

(72) Inventors: Joseph Justin Pritikin, Mountain View, CA (US); William Homer Chandler, JR., Milpitas, CA (US); Fayez Mahmood Khan, San Jose, CA (US)

(73) Assignee: AOPTIX TECHNOLOGIES, INC., Campbell, CA (US)

(21) Appl. No.: 13/525,156

(22) Filed: Jun. 15, 2012

(51) Int. Cl. G06K 9/62

(52) U.S. Cl. 382/116

(57) ABSTRACT

An enclosure works in conjunction with a mobile device to capture biometric identifiers. The mobile device has a screen on a first side and a camera on a second side opposite the first side. The enclosure at least partially covers the mobile device on the first and second sides. The enclosure includes a fingerprint subsystem configured to capture fingerprints with sufficient resolution for biometric identification. The fingerprint subsystem is located on a portion of the enclosure covering the second side of the mobile device. The enclosure includes an iris imaging subsystem configured to capture iris images with sufficient resolution for biometric identification. The iris imaging subsystem includes an iris imaging aperture facing outward from the portion of the enclosure covering the second side of the mobile device. The enclosure includes an electronic data interface configured to communicatively couple the fingerprint and iris imaging subsystems to the mobile device.

### TECHNICAL FIELD

This invention relates generally to biometric identification, and in particular to portable biometric identification systems.

### BACKGROUND

Biometric systems allow for the identification of human subjects using human traits that are either unique to each subject or are sufficiently uncommon so that one or more traits can be used to narrow down the number of possible subjects matching those traits. There are a number of different kinds of traits that may be used in biometric identification including, for example, iris images, face images, fingerprints, and recordings of a subject's voice. Traits captured in some form for use in biometric identification may be referred to generally as biometric identifiers.

However, capture of biometric identifiers is a difficult task. Each type of biometric identifier captured needs to be of sufficient quality that it can be used to narrow down the number of possible subjects matching the corresponding trait. A biometric identifier of sufficient quality may also be referred to as a “valid” biometric identifier. If the biometric identifier is of insufficient quality, it may not be possible to accurately or precisely determine whether the biometric identifier is associated with a given human subject. A poor quality biometric identifier may be entirely useless, or only of limited use in narrowing down the subjects matching the biometric identifier.

Generally, the systems used to capture biometric identifiers are designed with quality considerations in mind. However, capturing biometric identifiers with the requisite quality generally increases the difficulty of using these systems. For example, existing iris imaging systems are problematic in that they are generally only operable within a narrow range of distances between the subject and the iris capture system. Existing iris capture systems are generally bulky and therefore difficult for the user to reposition. As a result, it is difficult for the user to obtain the proper distance. In dangerous situations, difficulty in using the system amplifies the potential dangers associated with capturing iris images. For example, repositioning may increase the time taken to capture the iris image, and may require a comparatively small distance between the user and a potentially hostile subject.

As another example, digital fingerprint capture systems require the user to ensure that the correct finger is captured. Generally, the fingerprinting capture system must be presented to the subject for each feature, and subsequently the user must verify that each fingerprint was validly captured. The longer this process takes, the more burdensome this process is on both the user and the subject. Longer captures times may also increase the danger posed to the user in the case of a hostile subject.

### SUMMARY

An enclosure for a mobile device works in conjunction with the mobile device to capture a plurality different biometric identifiers of a subject. The mobile device displays a user interface on a screen of the device to guide the user in the capture of valid biometric identifiers. Together, the enclosure and the mobile device are able to work in conjunction to capture biometric identifiers based on iris images, face images, voice recordings, and fingerprints. The enclosure is configured to streamline the capture process, decreasing the overall knowledge and time required of the user to capture valid biometric identifiers. This also decreases the risk to the user in hostile environments. The mobile device also processes the captured biometric identifiers to determine if they are valid, and updates the display of the user interface accordingly.

The mobile device generally includes a screen for displaying the user interface, a camera on the opposite side of the mobile device from the screen that may be used to capture face images, an audio speaker, an input device such as a touch sensitive screen or keypad, and a microphone that may be used to capture voice recordings.

The enclosure at least partially covers the mobile device. The extent to which enclosure covers the mobile device may vary depending upon the implementation. The enclosure may be constructed of a single piece sleeve that fits around the mobile device. The enclosure may also be constructed using a front and back shells coupled at one end by a hinge and at the other end by a removably attachable coupling mechanism. The coupling mechanism may be attached to cover the mobile device and hold it in place with respect to the enclosure, or released to remove the mobile device from the enclosure. The enclosure includes an aperture for the screen of the mobile device as well as an aperture for the camera of the mobile device.

The enclosure includes an iris imaging subsystem for capturing iris biometric identifiers. The iris imaging subsystem includes an aperture that is positioned on the same side of the mobile device as the camera and on the opposite side of the mobile device from the screen. The iris imaging subsystem also includes its own camera that captures images in substantially the same direction as the camera of the mobile device.

The enclosure also includes a fingerprint subsystem for capturing fingerprint biometric identifiers. The fingerprint subsystem is also positioned on the same side of the mobile device as the camera and on the opposite side of the mobile device from the screen. The fingerprint subsystem includes a fingerprint scanner capable of creating a digital fingerprint of a subject. The fingerprint scanner is recessed from the outer surface of the enclosure to avoid unintended surface contacts.

The enclosure also includes an indicator subsystem for informing the user and subject of the status of fingerprint capture. The indicator subsystem is positioned on the same side of the enclosure as the fingerprint subsystem. The indicator subsystem reduces the need for the user to flip the mobile device over to check the screen for the status of fingerprint capture. Instead, the indicator subsystem provides this information visibly to the user. This helps reduces the time required to complete fingerprint capture.

The enclosure also includes a data interface for communicating data and control information between the enclosure and the mobile device.

### BRIEF DESCRIPTION OF THE DRAWINGS

FIG. 1 is a back side view of an enclosure for a mobile device, according to one embodiment.

FIG. 2 is a front side view of an enclosure for a mobile device, according to one embodiment.

FIG. 3 is a left top perspective view of an enclosure for a mobile device in an open configuration, according to one embodiment.

FIG. 4 is a back left top perspective view of an enclosure for a mobile device, according to one embodiment.

FIG. 5 is a left side view of an enclosure for a mobile device in a closed configuration, according to one embodiment.

FIG. 6 is a right side view of an enclosure for a mobile device in a closed configuration, according to one embodiment.

FIG. 7 is a top side view of an enclosure for a mobile device in a closed configuration, according to one embodiment.

FIG. 8 is a bottom side view of an enclosure for a mobile device in a closed configuration, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

An enclosure for a mobile device at least partially covers the mobile device and works in conjunction with the mobile device to capture a plurality different biometric identifiers of a subject. The mobile device displays a user interface on a screen of the device to guide the user in the capture of valid biometric identifiers. Together, the enclosure and the mobile device are configured to work in conjunction to be used by a user to capture and store several different kinds of biometric identifiers of a subject including, for example, face images, iris images, fingerprints, and voice recordings. The mobile device and enclosure also process the captured biometric identifiers to determine if they are valid, and updates the display of the user interface accordingly.

The enclosure is configured to streamline the capture process, decreasing the overall knowledge and time required of the user to capture valid biometric identifiers. This also decreases the risk to the user in hostile environments.

For clarity, the enclosure and the mobile device may be collectively referred to as a “combined biometric system” or simply as the “system”. With respect a received biometric input, the combined biometric system is capable of determining whether input is valid for use as a biometric identifier. Although each type of biometric identifier is different, generally the system compares the captured input against a quality metric to determine if it is sufficient for use in biometric identification. The quality metric may be based on a statistical correlation of various quality factors to the biometric performance of a database of similar identifiers. The quality metric may also incorporate comparing the captured input to a database of identifiers to determine whether the captured input is sufficient. The captured input may also be compared to an International Organization for Standardization (ISO) quality criterion. An ISO quality criterion may be incorporated into the quality metric.

### Mobile Device Components

Although not explicitly illustrated in the figures, the mobile device is portable computing device capable of being held and manipulated with only a single hand. The mobile device includes a screen for displaying the user interface that is manipulated by the user to control the capture biometric identifiers. The mobile device includes a camera on the opposite side of the mobile device from the screen. The camera may be used to capture face images for use as face biometric identifiers. In some instances, the mobile device may also include a second, “front-facing” camera on the same side of the mobile device as the screen.

The mobile device includes an audio subsystem including a microphone and audio speaker for the recording and playback of sound recordings, respectively. The audio subsystem also includes volume controls for controlling the volume level of the audio speaker, and a headphone input for plugging in external headphones. The audio speaker may be also be used to provide the user or the subject with instructions or feedback regarding the use of the system, as well as to provide indications of the progress or status of the device.

The mobile device includes at least one communication port configured to send and receive data between external devices such as the enclosure or another computing device (e.g., a desktop computer) (not shown). The mobile device also includes a network adapter configured to communicate with external computing devices that are not physically or electrically coupled to the mobile device. The network adapter may, for example, be a wireless card coupled to one or more antennae (not shown) configured to communicate using WiFi, 3G, LTE, or another radio frequency (RF) wireless communication standard.

The mobile device includes an input device to receive input from the user. The input device may, for example, one or more buttons, a keypad or QWERTY style keyboard, and/or a touch sensitive device integrated into the screen. The mobile device includes a separate activation button for turning on and off the mobile device. The mobile device may also include any number of other components not mentioned above, or may lack some of the features mentioned above.

### Enclosure Components

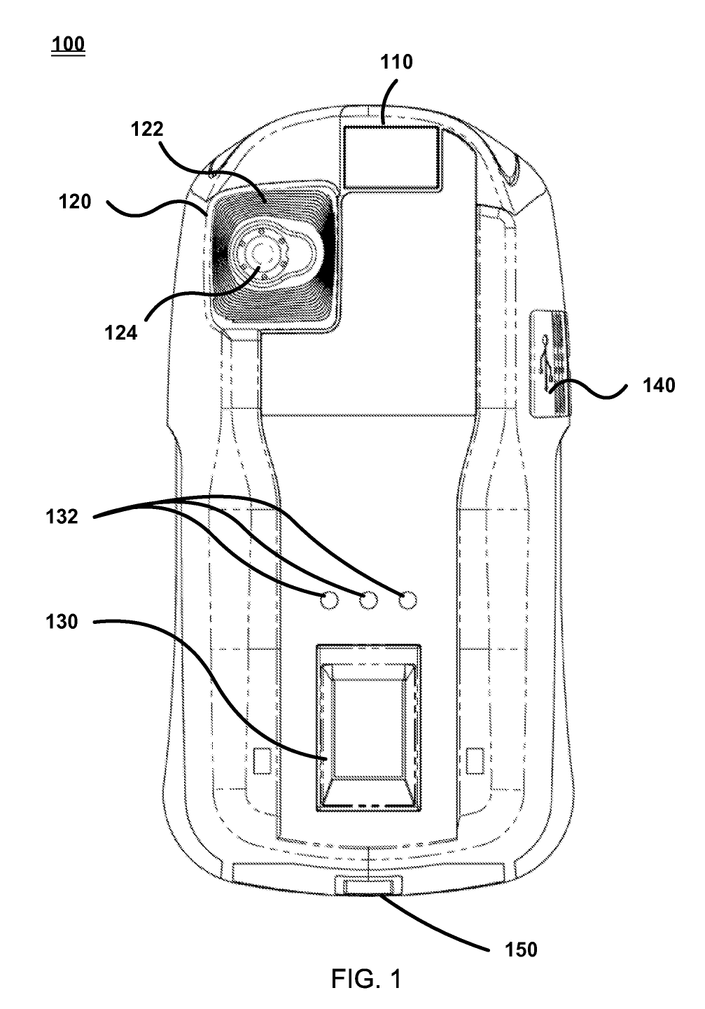

FIG. 1 is a back side view of an enclosure 100 for a mobile device (not shown), according to one embodiment. The back side view of the enclosure 100 depicts a number of the components of the enclosure, including a camera aperture 120 for the mobile device's camera, a iris camera aperture 110 for light to reach an iris imaging camera of an iris imaging subsystem, a fingerprint scanner 130 of a fingerprint subsystem, one or more lights 132, an external data port cover 140, and a strap attachment point 150.

The enclosure 100 includes the camera aperture 120 to allow the mobile device's camera to capture images over its entire field of view without being visually obstructed by the enclosure 100. The camera aperture 120 may include a cover 124 to protect the surface of the camera of the mobile device. In this case, the cover does not substantially (if at all) alter images captured by the mobile device's camera. The cover 124 may, for example, be made of glass or plastic.

To accommodate the other aspects of the enclosure 100, in some implementations the enclosure 100 will protrude a substantial distance from the surface of the mobile device. This may, for example, be due to the presence of an iris imaging subsystem 110 in relatively close proximity to the camera of the mobile device. As a consequence, the camera aperture 120 may be in the form of a cavity having side wall surfaces. The side wall surfaces of the cavity may unintentionally reflect and focus light into the camera of the mobile device, thereby affecting images captured by the camera. In one implementation, in order to prevent any additional light from entering the mobile device's camera due to the camera aperture 120, the camera aperture 120 has side walls shaped in a stepped 122 form. The stepped 122 portion of the side walls of the camera aperture 120 steps downward from the outer surface of the enclosure 100 down to either the cover 124 or surface of the mobile device. To reduce reflections from the stepped 122 portion from being collected by the camera of the mobile device, the stepped 122 portion may be coated with a black coating and/or an antireflective coating.

The enclosure 100 includes an iris camera aperture 110 for light to reach an iris imaging camera (not shown) of an iris imaging subsystem. The iris imaging subsystem allows the enclosure 100 to capture iris images for use as biometric identifiers. That is, the iris imaging system is able to capture iris images with sufficient resolution for use in biometric identification. In one embodiment, the iris imaging subsystem is able to capture iris images with a resolution of at least one of 200 microns or better, 100 microns or better, and 75 microns or better. Additional information regarding an implementation of an iris capture subsystem can be found in U.S. patent application Ser. No. 13/453,153, which is incorporated herein by reference in its entirety.

The iris camera aperture 110 is directed in substantially the same direction as the camera of the mobile device. To accomplish this, the iris camera aperture 110 is located on the same side of the enclosure 100 as the camera aperture 120, and therefore on the same side of the mobile device as the mobile device's camera. The remainder of the iris imaging subsystem may also be located on the same side of the enclosure 100 and mobile device as the iris camera aperture 110. Alternatively, the remainder of the iris imaging subsystem may be located elsewhere within the enclosure 100. The remainder of the iris imaging subsystem may include additional optical, sensing, and computing subsystems configured to carry out iris image capture.

The enclosure includes a fingerprint scanner 130 as part of a fingerprint subsystem for capturing digital fingerprints of a subject for use as biometric identifiers. That is, the fingerprint subsystem is able to capture fingerprints with sufficient resolution for use in biometric identification. In one embodiment, the fingerprint scanner 130 is a commercially available fingerprint scanner 130 such as the AUTHENTEC TCS1. In one embodiment, the fingerprint subsystem is able to capture fingerprints with a resolution of at least one of 100 dots per inch (DPI) or better, 300 DPI or better, and 508 DPI or better. In one embodiment, the fingerprint subsystem is able to capture platen sizes of subject acquisition profile (SAP) 10 (e.g., 0.5 inches by 0.7 inches), SAP 30 (e.g., 0.8 inches by 1 inch), and SAP 45 (e.g., 1.6 inches by 1.5 inches).

Due to the space taken up by the fingerprint scanner 130, in one implementation the fingerprint scanner 130 is located on the same side of the enclosure 100 as the camera aperture 120 and the iris camera aperture 110, as shown in FIG. 1. Positioning the scanner 130 on this side of the enclosure 100 reduces the total size of the enclosure 100. As different types of mobile devices have different layouts, in other implementations of the enclosure 100 the fingerprint scanner 130 may be located on a different side of the enclosure 100 in order to reduce the size of the enclosure 100.

In order to prevent damage to the fingerprint scanner 130, the fingerprint scanner 130 may be recessed from the outer surface of the enclosure 100. Placing the fingerprint scanner 130 in a recess allows the enclosure 100 to be placed on a flat surface with the mobile device's screen facing up while preventing the fingerprint scanner 130 from coming into contact with the flat surface.

Positioning the fingerprint scanner 130 on a different side of the mobile device (and enclosure 100) than the screen makes it more difficult for the user to look at the user interface on the screen to determine that each fingerprint has been validly captured. For example, if the user interface is configured to display on the screen whether or not a fingerprint has been validly captured, the user is forced to reposition the mobile device (e.g., flip over) after each fingerprint capture. Constant repositioning of the mobile device to switch between presentation of the fingerprint scanner 130 to the subject and presentation of the screen to the user increases the amount of time it takes a user to capture all fingerprints of a subject.

To make the system easier to use, the enclosure 100 includes one or more lights 132. The lights 132 make up part of an indicator subsystem. The indicator subsystem provides information and instruction, generally referred to as “fingerprint capture status indications” (or simply “status”) to the user regarding the status and operation of the fingerprint subsystem. The indicator subsystem may be implemented to provide visible indications and/or audible indications. If the indicator subsystem is configured to provide audible indications, the indicator subsystem may make use of the audio subsystem of the mobile device. In this case, a different sound may be played for each indication to be provided to the user.

If the indicator subsystem is configured to provide visible indications, the enclosure 100 includes one or more lights 132 as illustrated in FIG. 1. The lights 132 of the indicator subsystem are located on a side of the enclosure 100 that is visible concurrently with the fingerprint scanner 130. The activation of the lights 132 may be varied to provide the various indications. For example, the color of a light, the number of lights active, the time a light is active, the periodicity or pattern with which a light is active, and the intensity of a light all represents aspects of the activation which may be variously combined to provide the various indications.

Examples of fingerprint capture status indications that may be provided by the indicator subsystem include a ready to capture status for when the fingerprint scanner 130 is ready to capture a fingerprint of a subject, a capturing status for when the fingerprint scanner 130 is actively capturing a fingerprint, a processing status for when the system is processing a received fingerprint to determine whether it is valid, a valid fingerprint status indicating that a recently captured fingerprint is valid for use as a biometric identifier, and an invalid status indicating that a recently captured fingerprint is invalid and should be recaptured.

The enclosure 100 includes one or more data port covers 140 to cover the one or more data ports of a mobile device. The port cover 140 may be repositioned out of the way of the data port of the mobile device so that a cable may be connected to the port of the mobile device. When a cable is not connected to the port of the mobile device, the port cover 140 may be positioned to be flush with the remainder of the enclosure 100. The port cover 140 may be marked with the type of port it covers. For example, FIG. 1 illustrates a port cover 140 marked with a USB logo.

The enclosure 100 also includes a strap attachment point 150 for attaching strap to the enclosure 100. Attaching a strap to the enclosure 100 increases the convenience of the system as a whole, providing options to the user for securing the system against theft and damage.

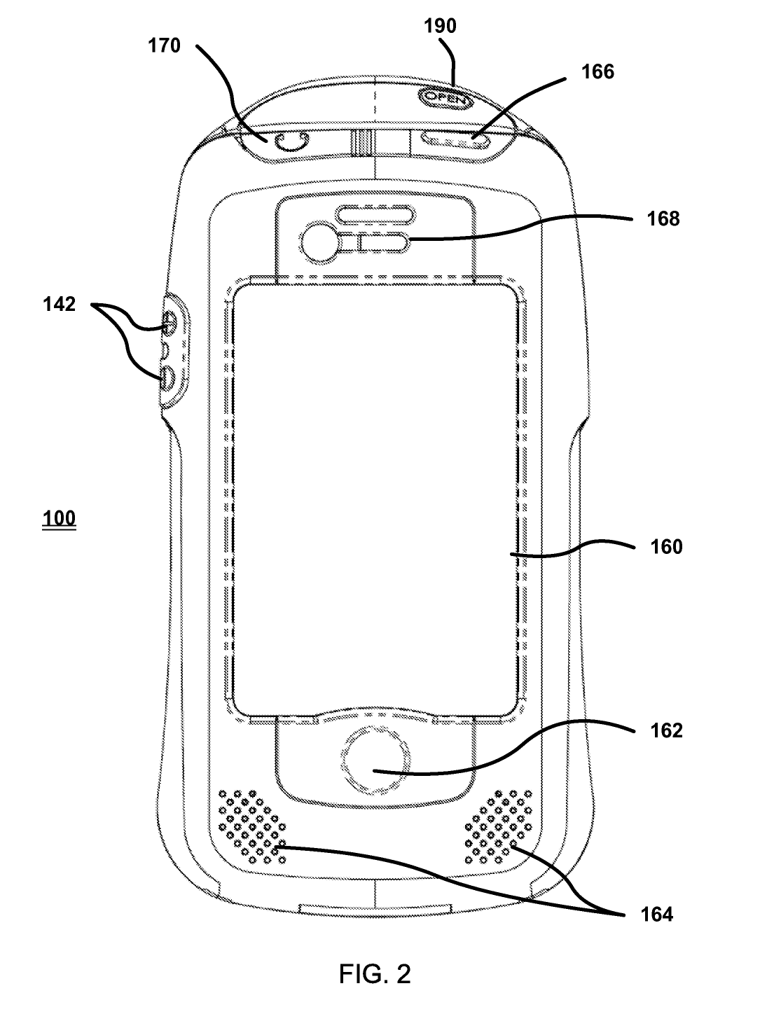

FIG. 2 is a front side view of an enclosure 100 for a mobile device, according to one embodiment. The front side view of the enclosure 100 depicts components of the enclosure 100 not visible in FIG. 1, including a screen aperture 160, one or more porous surfaces 164 so that the audio speaker of the mobile device is not muffled by the enclosure 100, a number of extensions 142, 166, and 162 to transfer manual control of buttons of the mobile device through the enclosure 100, a headphone port cover 170, a microphone, orientation, and light sensor port 168, and an open button 190 allowing removal of the mobile device from the enclosure 100.

The enclosure 100 includes a screen aperture 160 so that the screen of the mobile device is visible to the user through the enclosure 100. The screen aperture 160 is approximately the size of the screen. The screen aperture 160 may also include a cover to protect the surface of the screen.

The portion of the enclosure 100 covering the audio speakers and microphone of the mobile device are porous surfaces 164. The porous surfaces 164 reduce the extent to which sound transmitted out of the audio speakers and sound received by the microphone is blocked by the enclosure 100. As a result, the sound volume a short distance from the mobile device and enclosure 100 is approximately the same as it would be if the enclosure 100 were not present. In addition to transmitting sound, the porous surfaces 164 are also waterproof. In one implementation, the porous surfaces 164 are constructed using GORE-TEX, or another type of waterproof thin membrane material which allows for the transmission of sound. Alternatively, the enclosure 100 may include apertures for the audio speakers to prevent any sound transmitted from the audio speakers from being blocked by the enclosure 100.

The enclosure 100 includes a number of extensions 142, 166, and 162 that transfer manual control of the buttons of the mobile device through the enclosure 100. For example, by the extensions are configured to receive input pressure from a user and transfer that pressure through to the corresponding underlying button of the mobile device. Each extension is positioned to cover the underlying button. On the interior of the enclosure 100, each extension is configured to come into contact with the underlying button. Each extension may be visible marked on the exterior of the enclosure 100 to indicate the underlying button. In one case, the extensions are constructed of a substantially uncompressible material.

The enclosure 100 includes volume control extensions 142 that allow volume controls of the mobile device to be controlled through the enclosure 100. The enclosure 100 includes an activation button extension 166 for controlling the activation of the mobile device through the enclosure 100. The enclosure 100 includes one or more additional button extensions 162 for controlling any other buttons present on the outer surface of the mobile device.

The enclosure 100 includes a headphone port cover 170 for covering the headphone jack of the mobile device. The headphone port cover 170 may be repositioned so that headphones maybe connected to the headphone jack. When headphones are not connected to the headphone jack, the headphone port cover 170 may be positioned to be flush with the remainder of the surface of the enclosure. The headphone port cover 170 may also be marked to indicate its function.

The enclosure 100 includes a port 168 that exposes the mobile device's microphone. The port 168 also exposes the mobile device's proximity sensor so that the enclosure 100 does not interfere with the mobile device's ability to determine if it is being held against something, for example the head of a user making a phone call. The port 168 also exposes the mobile device's ambient light level sensor, which automatically controls the brightness of the screen of the mobile device to enhance readability under differing light conditions. The port 168 is waterproof, and is also able to transmit both light and sound.

The camera 120 and screen 160 apertures, port covers 140 and 170, port 168, porous surfaces 164, and extensions 162, 166, and 142 allow the enclosure 100 to more completely enclose the mobile device. An advantage of relatively more complete enclosure of the mobile device is that the surface of the system is more uniform and thus comfortable for the user. Additionally, more complete enclosure increases the protection offered to the mobile device by the enclosure 100, thereby reducing the chance that the mobile device will sustain physical damage.

The enclosure 100 is constructed to improve the environmental robustness of the mobile device covered by the enclosure 100. More complete enclosure also prevents dust and liquid ingress to the interior of the enclosure 100 and mobile device, thereby providing particulate and liquid protection. The enclosure 100 is configured to meet the International Electrotechnical Commission (IEC) 529 European Control Conference (ECC) water protection IPX-7 standard which requires protection against water immersion for thirty minutes at a depth of one meter. In other embodiments, these aspects of the enclosure 100 may be replaced by gaps in the enclosure through which the mobile device is directly accessible.

The enclosure 100 includes an open button 190 that when pressed opens the enclosure 100 into an open configuration allowing the mobile device to be removed from the enclosure 100. Although FIG. 2 illustrates the open button being located on the top of the enclosure 100, the open button 190 may be located anywhere on the enclosure 100.

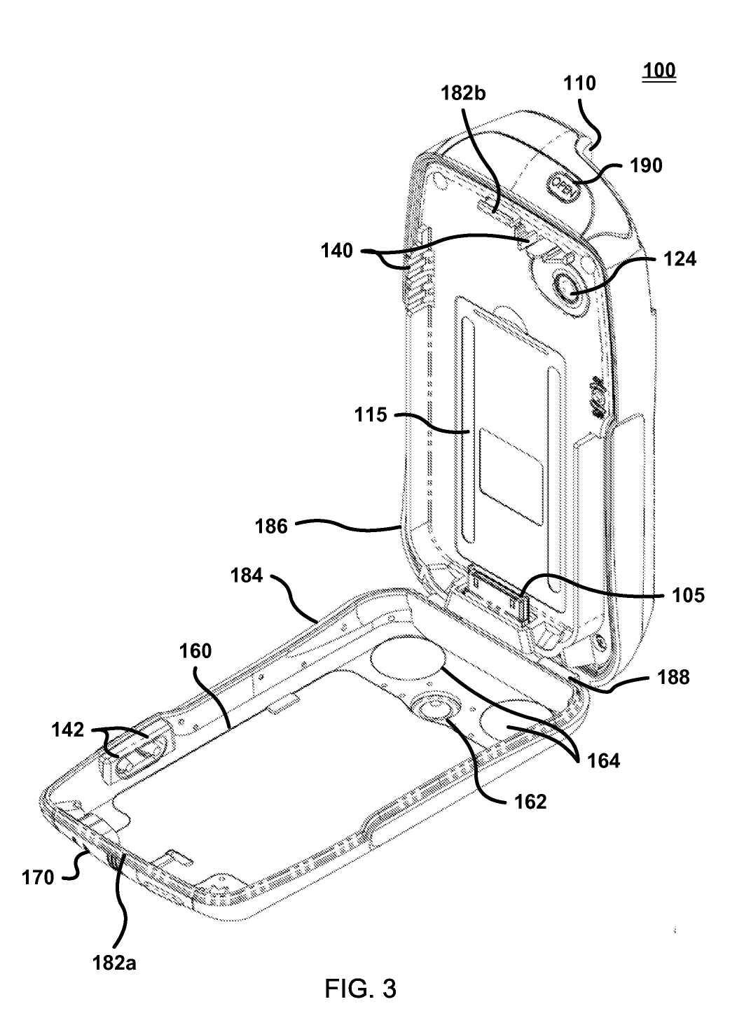

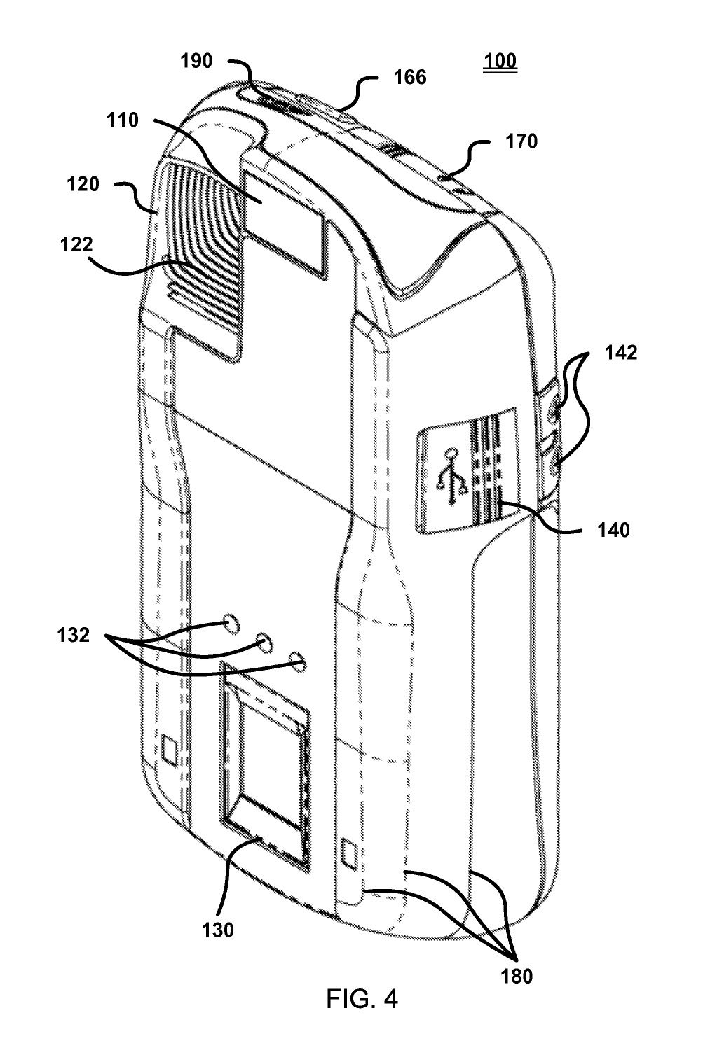

FIG. 3 is a left top perspective view of an enclosure for a mobile device in an open configuration, according to one embodiment. In the example embodiment of FIG. 4, the mobile device has been removed from the enclosure 100 and is not shown. Visible in FIG. 4 are the extensions 162 and 142. The enclosure 100 also includes one or more contact plates 140, a data interface 105, a backing place 115, a front shell 184, a back shell 186, a hinge 188, and a coupling mechanism 182.

The extensions 162, 166, and 142 of the enclosure 100 may be configured to come into contact with contact plates 140 rather than coming into contact directly with the underlying buttons of the mobile device. The contact plates 140 are configured to be more precisely positioned against the outer surface of the mobile device than the extensions 162, 166, and 142. The contact plates 140 increase the precision with which the extensions 162, 166, and 142 activate the underlying buttons, improving the responsiveness of the enclosure 100 to the user's inputs. The contact plates also help hold the mobile device more securely in place inside the enclosure 100.

The iris imaging, fingerprint, indicator subsystems of the enclosure 100 communicate with the mobile device through data interface 105. The data interface 105 allows for the exchange of commands, system status information, biometric input, and any other type of data between the enclosure 100 and the mobile device. In implementations where the enclosure 100 does not have its own computer, the data interface 105 may communicate directly with the components of the enclosure 100 such as the iris, fingerprint, and indicator subsystems.

Alternatively, the enclosure 100 may include its own computer (not shown) for controlling the operation of the components of the enclosure 100. This computer is in addition to, or in place of, any computing capability provided by the mobile device. The computer performs operations in response to biometric input received through the iris imaging subsystem and the fingerprint subsystem. The computer is also configured to send and receive commands from another external computing device, for example from the computer of the mobile device.

The computer may be specially constructed for the specified purposes of the enclosure 100, or it may comprise a general-purpose computer selectively activated or reconfigured by a stored computer program. Such a computer program may be stored in a computer readable storage medium which may include, but is not limited to, any type of magnetic-optical disks, read-only memories (ROMs), random access memories (RAMs), EPROMs, EEPROMs, magnetic or optical cards, application specific integrated circuits (ASICs), field programmable gate arrays (FPGAs), or any type of media suitable for storing electronic instructions, and each coupled to a computer system bus. Furthermore, the computer may include a single processor or may be of an architecture employing multiple processor designs for increased computing capability.

The data interface 105 may also provide physical support to assist the enclosure 100 in holding the mobile device in place within the enclosure 100. The enclosure 100 includes a backing plate 115 that also assists in holding the mobile device 100 in place within the enclosure 100.

The enclosure 100 at least partially covers the mobile device using a front shell 184 and a back shell 186. In one embodiment, the front shell 184 corresponds to the front side of the enclosure depicted in FIG. 2, and the back shell 186 corresponds to the back side of the enclosure depicted in FIG. 1. When the mobile device is in a closed configuration, the front shell 184 and 186 are coupled together to hold the enclosure 100 in place against the mobile device. In the closed configuration, the enclosure 100 is physically coupled to the mobile device in such a manner that when the enclosure 100 is moved, the mobile device also moves in unison. In addition to the coupling of the front 184 and back shells 186, unity of motion between the mobile device and the enclosure 100 may also be achieved using the data interface 105, backing plate 115, and contact plates 140, all of which help to hold the mobile device in place with respect to the enclosure 100. In the open configuration, for example after the open button 190 has been pressed, the mobile device may be removed from the enclosure 100.

The front 184 and back 186 shells are coupled together using one or more removably attachable coupling mechanisms 182. The coupling mechanism 182 may, for example, be a latch and groove device, a fixed latching device with an embedded latch release mechanism, or another similar coupling mechanism. The open button 190 transitions the enclosure to the open configuration by releasing the one or more coupling mechanisms 182. In one implementation, the front shell 184 includes a first portion of a coupling mechanism 182a. The back shell 186 includes a second portion of the coupling mechanism 184b. The first 182a and second 182b portions of the coupling mechanism 182 are removably attachable from each other. The front 184 and back 186 shells of the mobile device are coupled together by attaching the first 182a and second 182b portions of the coupling mechanism 182.

Depending upon the implementation, the front shell 184 and back shell 186 may also be hinged together with hinge 188. The hinge 188 removes ambiguity about how the coupling mechanism 182 and closed configuration function to cover the mobile device with the enclosure 100, thereby making the enclosure 100 easier to use. In one implementation, the portions of the coupling mechanism 182 are located near the distal ends of the front 184 and back 186 shells from the hinge 188 to help ensure that the mobile device is securely held within the enclosure 100. Alternatively, the front 184 and back 186 shells may be configured to be fully decoupled into separate pieces.

In one implementation, rather than using multiple shells, the enclosure 100 may be constructed of a single piece or sleeve. The sleeve may, for example, be constructed of an elastic material so that the enclosure 100 can be secured around the mobile device by stretching the material of the sleeve.

The remainder of the figures provide alternate views of the enclosure 100 in a closed configuration. FIG. 4 is a back left top perspective view of an enclosure 100 for a mobile device, according to one embodiment. FIG. 4 illustrates that the enclosure 100 includes moldings 180 to make the enclosure 100 easier to grip.

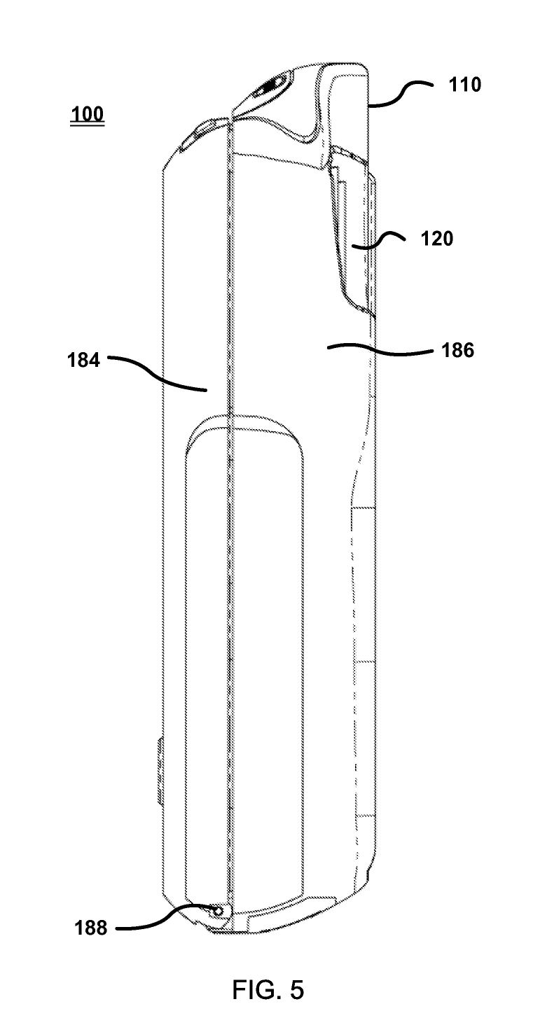

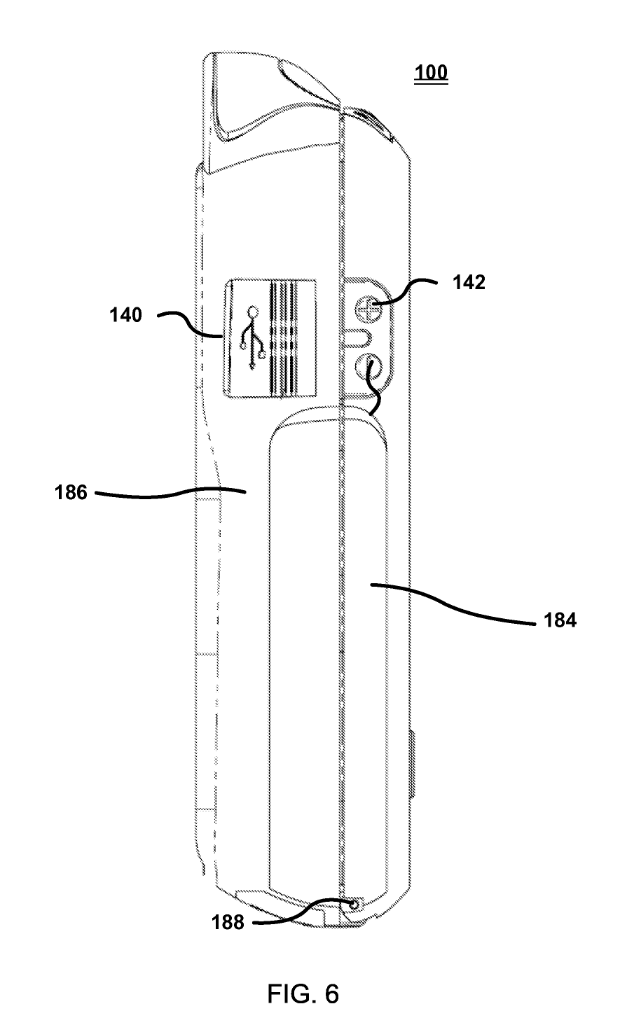

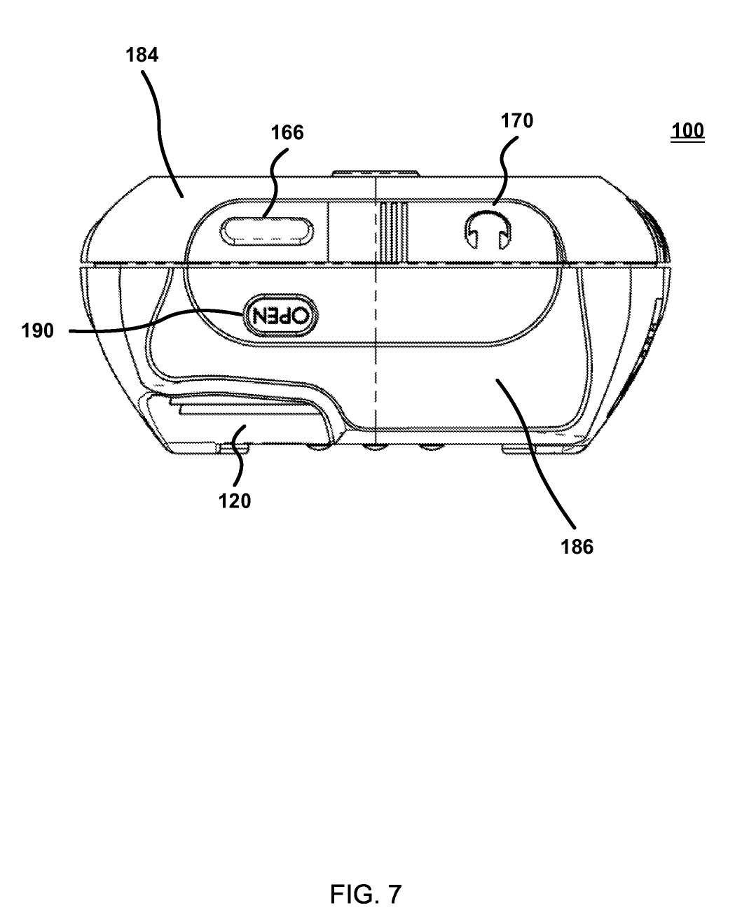

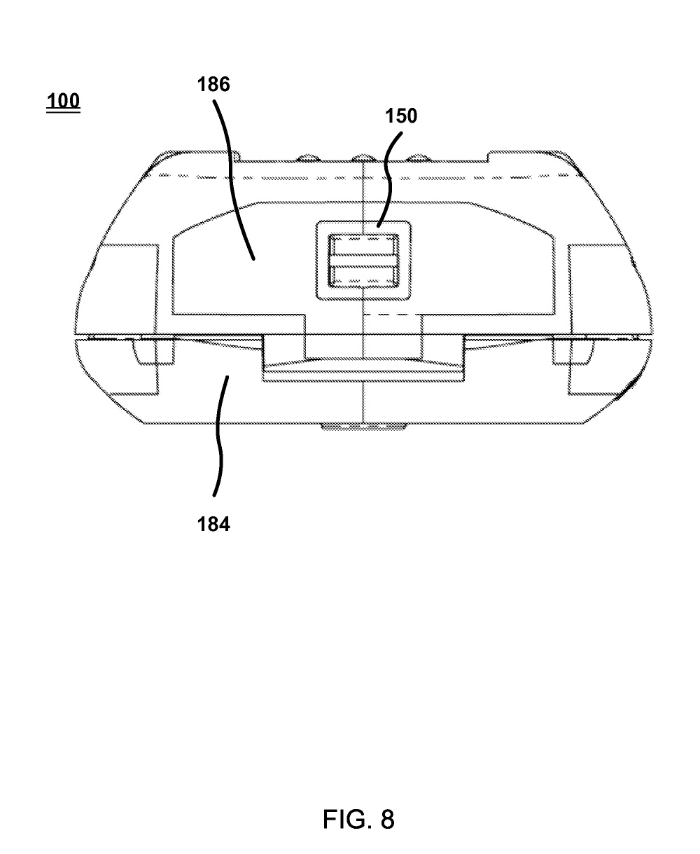

FIG. 5 is a left side view of an enclosure for a mobile device, according to one embodiment. FIG. 6 is a right side view of an enclosure for a mobile device, according to one embodiment. FIG. 7 is a top side view of an enclosure for a mobile device, according to one embodiment. FIG. 8 is a bottom side view of an enclosure for a mobile device, according to one embodiment.

### Additional Considerations

The foregoing description of the embodiments of the invention has been presented for the purpose of illustration; it is not intended to be exhaustive or to limit the invention to the precise forms disclosed. Although the detailed description contains many specifics, these should not be construed as limiting the scope of the invention but merely as illustrating different examples and aspects of the invention. Various other modifications, changes and variations which will be apparent to those skilled in the art may be made in the arrangement, operation and details of the method and apparatus disclosed herein without departing from the spirit and scope of the invention as defined in the appended claims.

Further, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention. Therefore, the scope of the invention should be determined by the appended claims and their legal equivalents.

What is claimed is:

1. A biometric enclosure for a mobile device, the mobile device having a screen on a first side and a camera on a second side opposite the first side, the enclosure at least partially covering the mobile device on the first and second sides, the enclosure comprising:
a fingerprint subsystem configured to capture fingerprints with sufficient resolution for biometric identification, the fingerprint subsystem located on a portion of the enclosure covering the second side of the mobile device;
an iris imaging subsystem configured to capture iris images with sufficient resolution for biometric identification, the iris imaging subsystem comprising an iris imaging aperture facing outward from the portion of the enclosure covering the second side of the mobile device; and
an electronic data interface configured to communicatively couple the fingerprint and iris imaging subsystems to the mobile device.

2. The enclosure of claim 1 wherein the fingerprint subsystem has a current fingerprint capture status, and wherein the enclosure further comprises an indicator subsystem, the indicator configured to provide an indication of the current fingerprint capture status.

3. The enclosure of claim 2 wherein the indicator subsystem is located on a side of the enclosure that is concurrently visible with the fingerprint subsystem.

4. The enclosure of claim 2, wherein the indicator subsystem comprises one or more lights.

5. The enclosure of claim 1 wherein the fingerprint subsystem is located on a portion of the enclosure covering the second side.

6. The enclosure of claim 1 wherein the iris imaging subsystem comprises an iris imaging aperture facing outward from the portion of the enclosure covering the second side.

7. The enclosure of claim 1, comprising a front shell at least partially covering the first side of the mobile device, the front shell comprising an aperture aligned with a screen of the mobile device.

8. The enclosure of claim 1, wherein the portion of the enclosure covering the second side of the mobile device comprises an aperture aligned with a camera of the mobile device.

9. The enclosure of claim 8, wherein the aperture comprises a cavity with stepped side walls.

10. The enclosure of claim 9, wherein the cavity comprises an anti-reflective coating on the stepped side walls.

11. The enclosure of claim 1, wherein the fingerprint subsystem comprises a fingerprint scanner located in a recess of the enclosure.

12. The enclosure of claim 1, wherein the enclosure comprises:
a front shell comprising a first portion of a coupling mechanism;
a back shell comprising a second portion of a coupling mechanism, the front and back shells coupled with a hinge, the first and second portions removably attachable to each other and configured so that:
when the first and second portions are attached to each other, the front and back shells substantially cover the mobile device, and
when the first and second portions are detached from each other, the mobile device is removable from the enclosure.

13. The enclosure of claim 12, wherein:
the first portion is located at a distal end of the front shell from the hinge; and
the second portion is located at a distal end of the back shell from the hinge.

14. A biometric enclosure for a mobile device, the enclosure at least partially covering the mobile device, the enclosure comprising:
a fingerprint subsystem configured to capture fingerprints with sufficient resolution for biometric identification;
an iris imaging subsystem configured to capture iris images with sufficient resolution for biometric identification; and
an electronic data interface configured to communicatively couple the fingerprint and iris imaging subsystems to the mobile device.
